(19) United States
(12) Patent Application Publication
(10) Pub. No.: US 2024/0017184 A1
(43) Pub. Date: Jan. 18, 2024

(54) FLEXIBLE NET COMPONENT FOR PLAYGROUND DEVICES

(71) Applicant: Landscape Structures Inc., Delano, MN (US)

(72) Inventors: Tory ROFF, Marshall, NC (US); Kent D. WUCHTERL, Forest Lake, MN (US); Steve J. SCHAUST, Pequot Lakes, MN (US); Randall G. WATERMILLER, Minnetonka, MN (US)

(21) Appl. No.: 18/351,801

(22) Filed: Jul. 13, 2023

Related U.S. Application Data
(60) Provisional application No. 63/389,428, filed on Jul. 15, 2022.

(51) Int. Cl. A63G 31/00

(52) U.S. Cl. CPC A63G 31/00

(57) ABSTRACT

Embodiments of a playground device that includes a net lattice are disclosed. The net lattice is attached either directly or indirectly to the playground device. First and second segments of a net rope are part of the net lattice and include a woven outer net rope layer that surrounds a woven inner net rope layer. A net clamp is also part of the net lattice. The first and second segments of the net rope run substantially parallel to one another through the net clamp. The net clamp secures the first segment of net rope to the second segment of net rope at the point at which they run substantially parallel to one another.

### CROSS-REFERENCE TO RELATED APPLICATION

The present application is based on and claims the benefit of U.S. provisional patent application Ser. No. 63/389,428, filed Jul. 15, 2023, the content of which is hereby incorporated by reference in its entirety.

### BACKGROUND

The design of components for incorporation into playground devices presents unique challenges. Consideration should be given to the fact that playground devices are prone to experiencing delayed maintenance, sometimes with years between part replacements. Consideration should also be given to optimizing to avoid injuries caused, for example, by falls. Playground device components should also be designed to withstand extreme environmental considerations—often times snow and ice in the winter followed by extreme heat and precipitation in the spring/summer. Consideration should also be given to the fact that playground device components are often used by children having little or no supervision. Finally, many if not most playground device components are left out in the open with little or no surveillance, which leaves them open to vandalism. With these and other factors coming into play, it takes an excellent designer to create desirable playground device components. There is an ongoing need for well-designed components from which playground device designers may pick and choose with confidence.

### SUMMARY

Embodiments of a playground device that include a net lattice are disclosed. The net lattice is attached either directly or indirectly to the playground device. First and second segments of a net rope are part of the net lattice and include a woven outer net rope layer that surrounds a woven inner net rope layer. A net clamp is also part of the net lattice. The first and second segments of the net rope run substantially parallel to one another through the net clamp. The net clamp secures the first segment of net rope to the second segment of net rope at the point at which they run substantially parallel to one another.

These and various other features and advantages that characterize the claimed embodiments will become apparent upon reading the following detailed description and upon reviewing the associated drawings.

### BRIEF DESCRIPTION OF THE DRAWINGS

FIG. 1 is a perspective view of a portion of a net lattice.

FIG. 2 is a perspective view of a portion of a net lattice.

FIG. 3 is a perspective view of a portion of a net lattice.

FIG. 4 is a perspective view of a portion of a net lattice.

FIG. 5 is a perspective view of a playground device.

FIG. 6 is a perspective view of a rope hook.

FIGS. 7A-7B are perspective views of a hook cover.

FIG. 8 is a perspective view of a playground device.

FIGS. 9A-9B are perspective views of a rope hook coupling assembly.

FIG. 10 is a sectional view of a net rope.

FIG. 11 is a cross-sectional view of a net rope.

FIG. 12 is a cross-sectional of a border rope.

FIG. 13 is a flow diagram demonstrating a process for forming a net lattice.

FIGS. 14A-14B are perspective views of a net clamp.

FIG. 15 is a perspective view of a portion of a playground device.

### DETAILED DESCRIPTION OF ILLUSTRATIVE EMBODIMENTS

As playground devices become more versatile and entertaining, net type components have become increasingly common. For many playground devices, it is ideal that a net type component comfortably accommodate multiple users of a variety of different sizes. For many playground devices, it is also ideal for a net type component to demonstrate long term strength and durability. Embodiments described herein address these and other design considerations for net type playground device components.

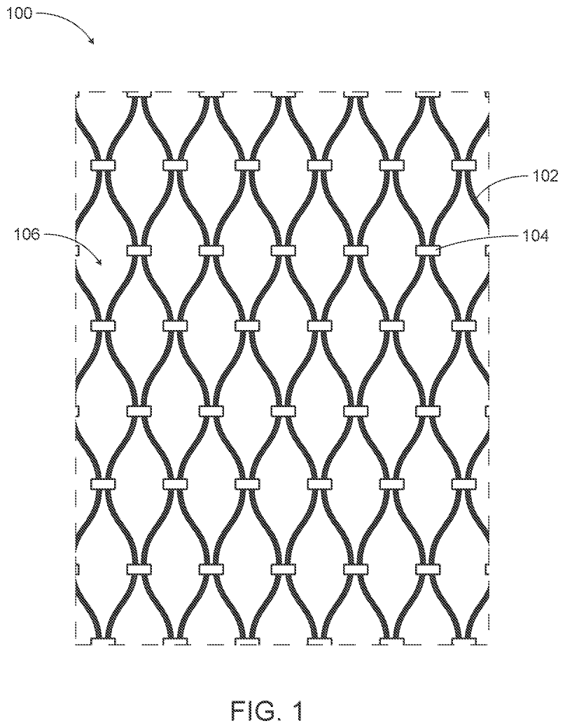

FIG. 1 is a perspective view of a portion of a net lattice 100. Net lattice 100 illustratively includes one or more net ropes 102 distributed at least substantially uniformly to form net lattice 100. Net rope 102 may include a plurality of separate net rope segments, for example segments of same or varying lengths. Alternatively, it may be one continuous net rope 102 having a length sufficient to form some or all of net lattice 100.

Net lattice 100 also illustratively includes a plurality of net clamps 104. As shown, a network of net clamps 104 are disposed at least substantially uniformly. For example, as shown in FIG. 1, there are groupings of net clamps 104 formed in a line in the horizontal direction (rows of clamps from left-to-right in FIG. 1), and then there are groupings of net clamps 104 formed in a line in the vertical direction (columns of clamps from top-to-bottom in FIG. 1). Each net clamp 104 pulls two portions of net ropes 102 toward one another to form the visually appealing pattern that is inherent to net lattice 100. As is further detailed below, net clamps 104 are in one embodiment configured to secure the portions of net ropes 102 next to one another (may or may not be touching depending on net clamp 104 design) through a crimping style of engagement between the net clamps 104 and the portions of the net ropes 102. However, it is expressly contemplated that other modes of securing together portions of net rope 102 can be utilized (e.g., welding).

As is shown in FIG. 1, the positioning of net clamps 104 relative to one another determines the size, shape, and distribution of spaces incorporated into the pattern of the net lattice 100. An example of a single space so formed in the net lattice 100 is designated in FIG. 1 by reference numeral 106. However, this space 106 is repeated throughout the bulk of net lattice 100, as a result of the substantially uniform distribution of net clamps 104 into aligned columns and rows of net clamps 104. The spaces 106 formed in the lattice 100 can illustratively be modified by changing the relative positioning of the net clamps 104. For instance, by spacing consecutive columns or rows of net clamps 104 closer together, the size of adjacent net spacings 106 will decrease. Of course, it follows logically then that spacing consecutive columns or rows of net clamps 104 further apart will increase the size of adjacent net spacings 106. Further, it is not necessary for net clamps 104 to be consistently aligned into columns or rows. The distribution of net clamps can be organized in infinite combinations so as to produce consistent or even inconsistent spacings 106 throughout net lattice 100. In other examples, net clamps 104 are inconsistently spaced in one or more locations thereby causing variations in the size, shape, and or configuration from one spacing 106 to the next. For example, the spacings 106 across net lattice 100 can just as easily be varied in a consistently or inconsistently organized way depending on the requirements of a given application.

The securing of net clamps 104 to the portions of net ropes 102 illustratively causes the elongated centerline axis of net ropes 102 to be fixed permanently in a common plane—within each net clamp 104. However, net clamps 104 are adjacent to one another in a common column or row are allowed freedom of movement relative to one another. In this way, net lattice 100 is naturally flexible. Given the described scheme of connecting portions of net ropes 102 together, net lattice 100 is configured overall to respond by conforming to accommodate an applied weight or pressure. In one embodiment, which will be described in greater detail in relation to other Figures, the net ropes 102 are also constructed with a firm but flexible design that causes net lattice 100 then reassume some or all of its original shape and configuration upon relief of the weight or pressure. For example, if a user sits on the net lattice 100, net lattice 100 tolerates a comfortable conformity to the user's body. Upon the user leaving exiting the net lattice 100, it will illustratively automatically recover some or all of the shape and configuration that it had before the user sat down. Thus, net lattice 100 promotes both sound device for convenient climbing and elasticity for comfortable lounging—all while maintaining the pleasing aesthetic features of the lattice.

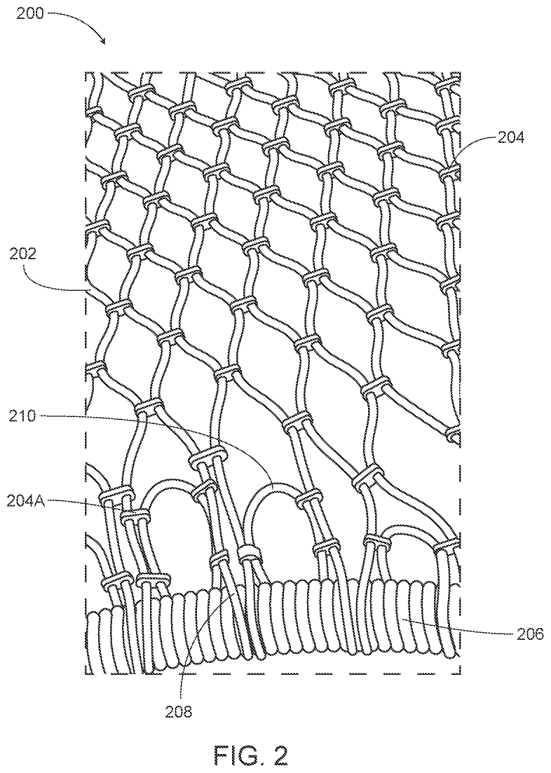

FIG. 2 is a perspective view of a portion of a net lattice 200. Net lattice 200 includes similarities to the net lattice 100 of FIG. 1, and similar components will be similarly numbered in FIG. 2. One or more net ropes 202 are illustratively connected together in various locations utilizing net clamps 204 so as to form the net lattice 200. Net lattice 200 then further includes a border rope 206 disposed along an outer perimeter of the net lattice 200 to provide support and maintain tension. Border rope 206 illustratively has a larger diameter relative to the one or more net ropes 202. Border rope 206 is configured to support looping portions of net rope 202. As such, the border rope 206 provides termination or transition points 208 for the one or more portions of a net rope 202. Termination or transition points 208 can include any number of loops around border rope 206. However, for many applications, a low number of loops such as 1-3 will provide appropriate structural integrity without adding additional material costs unnecessarily.

As is also shown in FIG. 2, in one embodiment, a transition loop 210 formed in one or more net ropes 202 is provided to further facilitate an anchoring or transition at border rope 206. In one embodiment, a free, distal end of one or more net ropes 202 is secured at or proximate to a termination or transition point 208. In another embodiment though, net rope 202 is anchored and transitioned at a point 208 without incorporation of any free end—but rather the net rope 202 is transitioned (looped) one or more times around border rope 206 (with or without incorporation of a transition loop 210) before back across the net lattice 200 as a next adjacent segment of net rope 202. In this manner, the entire lattice 200 (excluding border ropes 206, etc.) can be comprised of a single stretch of net rope 202. Additionally, as illustrated in FIG. 2, transition loop 210 and or any portion of a net rope 202 are optionally further secured and/or oriented utilizing one or more extra net clamps 204A. In this way, uncoiling of the terminations or transitions of net rope 202 at border rope 206 is mechanically discouraged.

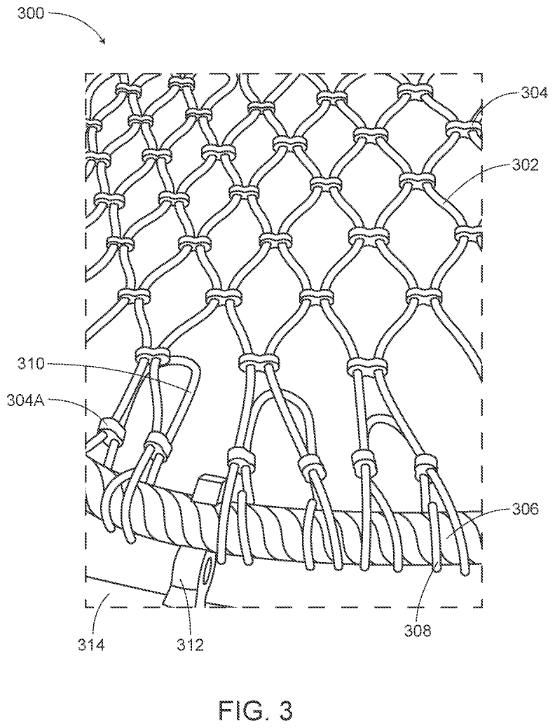

FIG. 3 is a perspective view of a portion of a net lattice 300. Net lattice 300 includes similarities to the previously described net lattices 100 and 200, and similar components will be similarly numbered in FIG. 3. Net lattice 300 is particularly similar to net lattice 200 in FIG. 2. Net lattice 300 includes one or more net ropes 302 and net clamps 304 configured to couple together to form the structure and pattern of net lattice 300. Net lattice 300 further includes border rope 306. Portions of net rope 302 have been routed to form a plurality of rope loops 310 (only a representative one has been labeled), wherein rope loops 310 are formed adjacent to where portions of net rope 302 are looped around a border rope 306 forming a number of terminations or transitions at a termination or transition point 308. For example, the labeled rope loop 310 illustratively terminates or transitions around border rope 306 two times and is secured in place via a plurality of extra net clamps 304A, as shown. However, in other examples, more or less loops around border rope 306 may be utilized. In this way, uncoiling of the terminations or transitions of net rope 302 about border rope 306 is mechanically discouraged.

One thing that is different about net lattice 300 is the inclusion of a rope hook 312 to facilitate securing a border rope 306 to a playground device 314. Rope hook 312 is illustratively configured to support border rope 306 within a hooked portion of the rope hook 312. By supporting the border rope 306, rope hook 312 aids in retaining tension across net lattice 300. In one example, rope hook 312 may be compressed or crimped around border rope 306. In other examples, such as those described below in relation to other Figures, border rope 306 is securely locked in rope hook 312 by fastening pressing it into the hooked portion of rope hook 312 and then securing it with a hook cover (not shown in FIG. 3).

In one embodiment, rope hook 312 is coupled to device 314 by welding. However, it is expressly contemplated that other modes of coupling rope hook 312 to device 314 may be utilized. Through incorporation of one or more rope hooks 312, the border rope 306 and therefor net lattice 300 may be secured and coupled to most any playground device. Those skilled in the art will appreciate that there are other suitable ways other than a rope hook to couple the net lattice embodiments described herein to a playground device—such as but not limited to clamping or through the incorporation of eyebolts or other similar connectors that may or may not require welding.

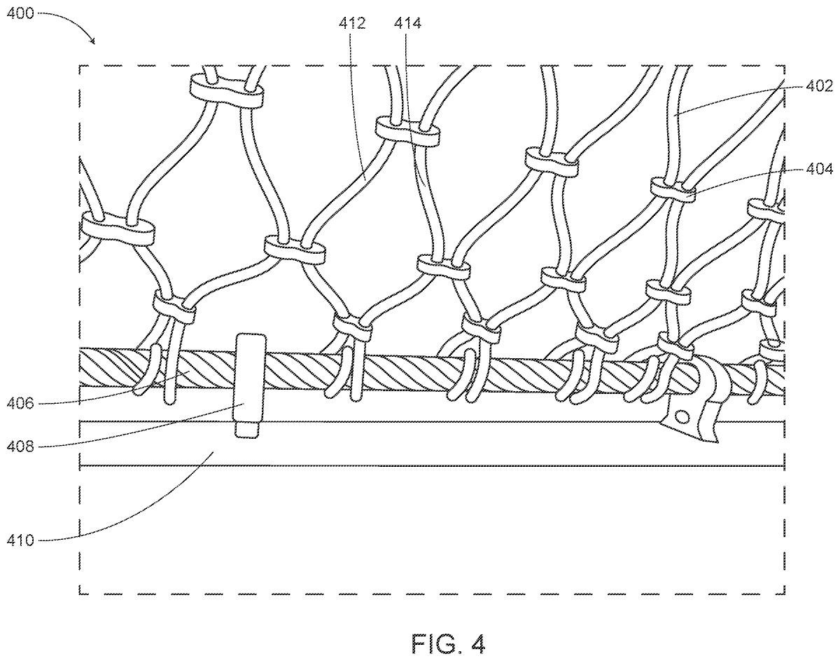

FIG. 4 is a perspective view of a portion of a net lattice 400. Net lattice 400 includes similarities to the previously described net lattices 100, 200 and 300, and similar components will be similarly numbered in FIG. 4. Net lattice 400 is particularly similar to net lattice 200 in FIG. 2. Net lattice 400 includes one or more net ropes 402 and net clamps 404 configured to form the structure and pattern of the net lattice 400. A border rope 406 illustratively supports an outer perimeter of net lattice 400. The border rope 406 supports the one or more net ropes 402. In one embodiment, net clamps 404 are positioned and configured to guide net ropes 402 into a clinching engagement with border rope 406 that limits or prohibits rubbing or other abrasive action between the net rope 402 and border rope 406. As such, the shape of openings in net lattice 400 may or may not be as consistent as the shape of openings further away from the border rope 406.

In one embodiment, as shown in FIG. 4, net rope 402 has no loose end but instead terminates or transitions (i.e., loops) one or more times around border rope 406 before continuing in an opposite direction to form an adjacent run of rope 402 in the overall net lattice 400 structure. For example, in one embodiment, a segment of net rope 412 runs towards border rope 406 and terminates or transitions (i.e., loops) about border rope 406 a number of times (e.g., two times) before proceeding in an opposite direction as another segment 414. Segment 412 and segment 414 are clamped together by net clamps 404 (may or may not touch one another depending on net clamp 404 design). This routing of net rope 402 towards and away from border rope 406 plus the clamping with net clamps 404 produces the shape of net lattice 400, as shown. All of this being said, it is also contemplated that individual portions of net rope 402 could be utilized instead of the illustrated continuous rope 402 design.

Additionally, as shown in FIG. 4, border rope 406 is secured to a playground device 410 by a plurality of rope hooks 408. Rope hooks 408 may be secured to playground device 410 by, for example, welding. However, it is expressly contemplated that other means of fixing rope hooks 408 to device 410 may be utilized in the alternative. In operation, the plurality of rope hooks 408 secure border rope 406 to playground device 410, thereby providing sufficient tension and integrity of net lattice 400 as an integral component of the broader playground installation of which playground device 410 is a part.

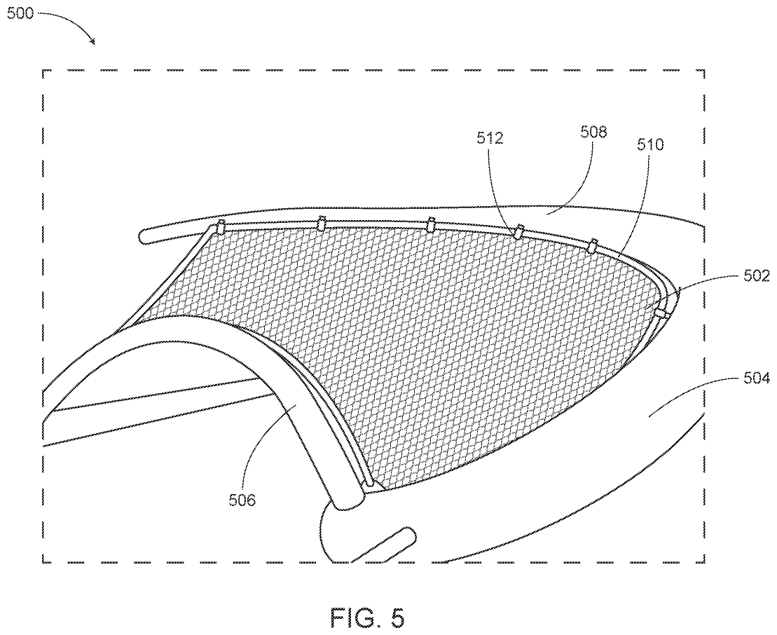

FIG. 5 is a perspective view of a playground device 500 that incorporates a net lattice 502. Net lattice 502 is illustratively configured so as to be consistent with the embodiments of net lattices described in relation to any of the previous FIGS. 1-4. As shown, net lattice 502 generally covers an interior space within a device frame 504. A border rope 510 is configured to provide support within the net lattice 502 structure and also facilitates a coupling to the device frame 504. Border rope 510 is secured to frame 504 utilizing a plurality of rope hooks 512.

In one embodiment, frame 504 includes one or more curved portions 506. In another embodiment, straight portions are included as well, such as straight portion 508. In either case, border rope 510 is illustratively configured to have sufficient pliability to line the perimeter of both curved portion 506 and/or straight portion 508 while retaining the tension across the net lattice 502. Those skilled in the art will then appreciate that the size, shape and configuration of the playground device and corresponding net lattice features can change depending on the requirements for a given playground installation.

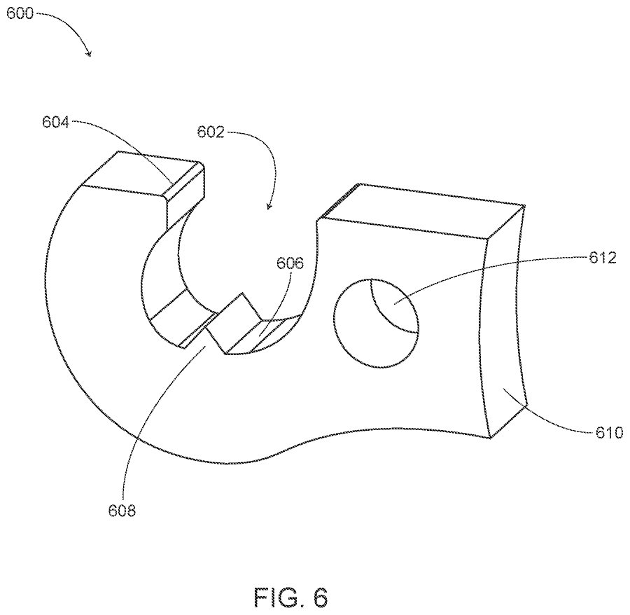

FIG. 6 is a perspective view of a rope hook 600. As shown, rope hook 600 includes a concave portion 602 configured to house and support a border rope, such as the examples of border ropes described above relation to other Figures. Concave portion 602 is illustratively sized sufficiently to fit any border rope that fulfills applicable requirements for a given installation. Rope hook 600 further includes a lip portion 604 configured to further secure and retain the border rope within concave portion 602. Additionally, in one embodiment, rope hook 600 includes a smooth portion 606 and jagged portion 608 disposed within concave portion 602. Jagged portion 608 is configured to further secure the border rope by applying a frictional, digging or drag force to prevent rotation and/or translation of the border rope within concave portion 602. In one embodiment, rope hook 600 further includes surface 610 which configured to couple to a desired playground device. As shown, surface 610 is generally depicted as flat in order to allow for suitable coupling to the playground device. For example, rope hook 600 may be coupled to a playground device at surface 610 by welding surface 610 to the playground device. However, in other embodiments, surface 610 may be curved in any suitable manner to allow for fitting of rope hook 600 to a playground device. In one embodiment, rope hook 600 has a length of about 2.25 inches and a relative thickness of about 0.5 inches. However, it is expressly contemplated that a different length and thickness may be utilized as well. Additionally, in one embodiment, rope hook 600 includes aperture 612. Aperture 612 is configured to receive one or more fasteners therein. The fasteners may be used, for example, to secure a hook cover onto rope hook 600. The fastener used in aperture 612 may be, for example, a bolt, screw, or any other fastener suitable for protrusion into aperture 612. In one embodiment, aperture 612 is a threaded aperture appropriate for a corresponding threaded fastener.

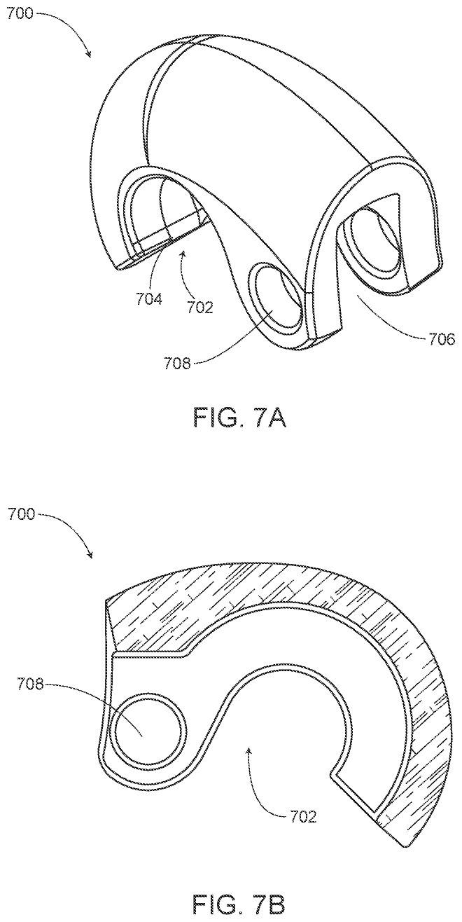

FIGS. 7A and 7B are perspective views of a hook cover 700. Hook cover 700 includes an internal portion 702 configured to receive a rope hook therein. The rope hook may be, for example, the rope hook 600 described above with respect to FIG. 6. Internal portion 702 includes a first gap 704 configured to facilitate engagement of a lip portion of the rope hook to hook cover 700, and a second gap 706 configured to facilitate engagement of a body portion of the rope hook to hook cover 700. Hook cover 700 may, in one embodiment, have a length of about 2.25 inches, a height of about 1 and 13/16 of an inch, and a width of about 1.125 inches. Additionally, hook cover 700 further includes an aperture 708 configured to allow insertion of a fastener therethrough. In installation, the fastener illustratively protrudes through aperture 708 and additionally through the aperture provided in the rope hook in order to couple hook cover 700 and the rope hook together. The fastener utilized may be, for example, a bolt, screw, or any other fastener suitable for protrusion though aperture 708. In one embodiment, aperture 708 is a threaded aperture. Additionally, in one embodiment, aperture 708 has a diameter of about 0.410 inches. In operation, hook cover 700 is configured facilitate a housing of the rope hook and provide a protective barrier from any intentional or accidental damage to the rope hook and/or a border rope that is supported by the rope hook.

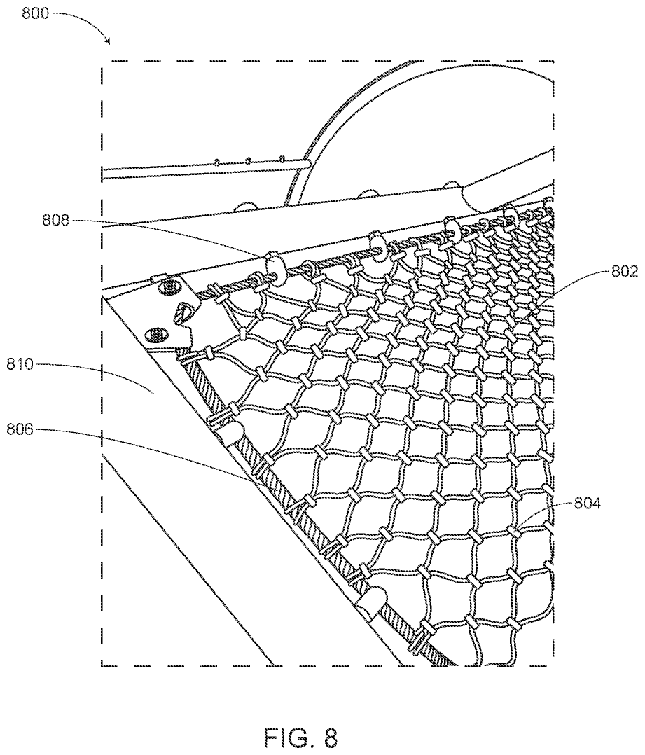

FIG. 8 is a perspective view of a playground device 800 incorporating elements described above in relation to other Figures. Device 800 includes a net lattice 802 having a plurality of net clamps 804 and one or more border ropes 806. Border rope 806 is configured to be inserted into and supported by a plurality of rope hooks 808. As shown, each rope hook 808 includes a hook cover. The hook cover is illustratively consistent with the hook cover described above with respect to FIGS. 7A-7B. The hook cover shown serves to further fasten border rope 806 to rope hook 808 while discouraging tampering. Additionally, as shown, rope hook 808 protrudes slightly outside of the hook cover such that it may be coupled to frame 810, such as but not limited to being secured by welding.

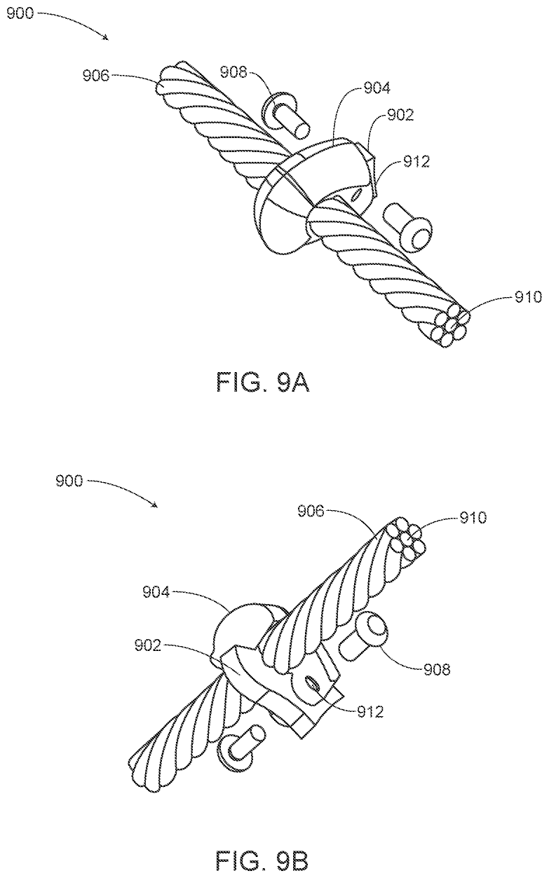

FIGS. 9A-9B are perspective views of a rope hook coupling assembly 900. Assembly 900 includes a rope hook 902 fastened to hook cover 904. As shown, a border rope 906 extends through a concave portion of rope hook 902 and hook cover 904 such that it is secured into place. Border rope 906 and/or rope hook 902 are illustratively sized such that there is little to no gap for movement when border rope 906 is secured within the concave portion of rope hook 902.

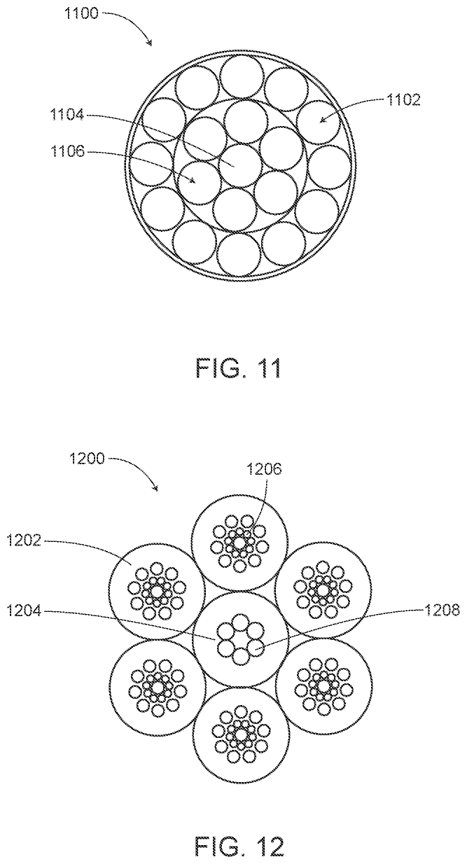

Also shown in FIGS. 9A-9B is a cross section of border rope 906. As shown, border rope 906 illustratively includes six edge ropes 920 and a rope core 910. However, in another example, a different number of edge ropes and/or rope cores may be utilized. In one embodiment, the rope edges are reinforced, for example, with steel wire. Additionally, in one embodiment, rope core 910 is a steel core, but could just easily be comprised of a different material such as a polypropylene core material. In one embodiment, the material is selected to make it difficult to tear and/or otherwise damaging border rope 906. In one embodiment, the diameter of border rope 906 is about 20 millimeters (mm). Additional embodiments configurations for the composition of border rope 906 will be discussed below in relation to FIG. 11.

Assembly 900 additionally includes one or more fasteners 908 configured to protrude through aperture 912 and fasten hook cover 904 to rope hook 902. As illustrated, two fasteners 908 are used, wherein each fastener is applied on opposite side of rope hook 902 and hook cover 904. However, in other embodiments, one fastener may be used with aperture 912. Fasteners 908 may be, for example, threaded fasteners. However, in other embodiments, other fasteners may be used, such as a non-threaded fastener.

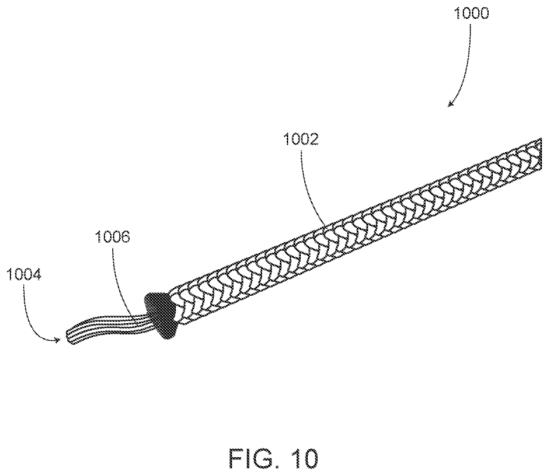

FIG. 10 is a sectional view of a net rope 1000. In one embodiment, net rope 1000 is the net rope or ropes used to form the net lattice embodiments described above in relation to other Figures. Net rope 1000 illustratively includes a plurality of woven rope fibers 1002 that surround a rope core 1004 that is difficult to see in FIG. 10 because it is itself surrounded by a plurality of woven strands 1006. In one embodiment, each woven strand 1006 and/or rope core 1004 is itself a weave of individual strands. However, for now, it is useful for the purpose of the present description to think of woven strands 1006 and rope core 1004 as each individual elements in their own right.

As was alluded to in the description of previous Figures, one or more net ropes 1000 are coupled together utilizing a plurality of net clamps so as to form a net lattice. The outer weave of rope fibers 1002 serves to protect the woven strands 1006 and the rope core 1004 from damage, while also providing a comfortable lounging and functional climbing surface for playground component users. Further, rope fibers 1002 also isolate playground users from the what would be relatively sharper, hotter, colder and otherwise uncomfortable to the touch woven strands 1006 and/or rope core 1004. In one embodiment, rope fibers 1002 are formed of braided polyester. However, in other embodiments, another material may be used to form rope fibers 1002 (e.g., polyethylene).

The woven strands 1006 and rope core 1004 together are configured to further discourage damage to the one or more net ropes 1000 over time. For instance, woven strands 1006 and rope core 1004 together reduce the likelihood that the one or more net ropes 1000 will outright break, tear be cut through or be compromised in some way by a vandal. Additionally, the relative rigidity of woven strands 1006 and rope core 1004 causes the structural integrity and shape of the net lattice to be maintained when it is not under pressure while also allowing for temporary shape change when the net lattice is under pressure such as by a user comfortably laying upon the net lattice. The relative rigidity of the woven strands 1006 and rope core 1004 in combination with their positioning in the rope clamps of the net lattice cause a degree of shape memory functionality, wherein the net lattice will deform when under pressure but naturally and automatically will return partially or completely to a non-deformed shape when not under pressure.

FIG. 11 is a cross-sectional view of a net rope 1100, which is illustratively consistent in all or most ways with net rope 1000. In other words, in one embodiment, the cross-sectional view is a cross section of net rope 1000. As shown, net rope 1100 includes an outer layer 1102 comprised of 12 (not by limitation) individually woven rope fibers (these were referred to as rope fibers 1002 in relation to FIG. 10). In one embodiment, the rope fibers of outer layer 1102 are formed of a polyester material. In another example, the rope fibers may be comprised of a fabric or some other relatively soft material (i.e., soft relative to the more rigid materials around which it is woven).

The diameter of net rope 1100 is defined by the overall diameter of outer layer 1102. For example, the diameter is approximately 6.6 millimeters (mm). However, it is expressly contemplated that net rope 1100 may have a larger or smaller diameter depending on the requirements of a given installation. A diameter in the range of 5-18 mm is effective to balance comfort for laying on with function for an appealing climbing experience. A diameter of less than 12 is especially effective for a shape memory effect wherein net lattice shape is automatically reassumed when pressure is removed (e.g., a lounging person exists). In one embodiment the overall net rope 1100 is dipped or coated in a protective material to further reduce the likelihood of fraying, etc. Such a coating though will be light and unlikely to add significantly to the diameter.

Net rope 1100 also includes inner layer 1106 comprised of six (not by limitation) individually braided strands (referred to in FIG. 10 as woven strands 1006) that are comprised of a more rigid material, such as a metallic material. Inner layer 1106 may or may not also be dipped or coated in a light protective layer. The inner layer 1106 provides damage and tamper resistance. In one embodiment, the lay length of the braided strands in this layer is about 23 mm. However, it is expressly contemplated that different lay lengths can be selected depending upon the requirements of a given application.

Finally, net rope 1100 further includes a rope core 1104 (referred to as rope core 1004 in FIG. 10) disposed within outer layer 1102 and inner layer 1106. The diameter of rope core 1104 is illustratively about 2.25 mm, though different diameters may be preferable given the requirements of a given installation. Rope core 1104 is configured to help retain structural integrity of the net lattice while also preventing damage to the net rope over time. For instance, rope core 1104 minimizes the likelihood of rope tearing, etc.

In one embodiment, rope core 1104 is formed from a metal material, such as steel. In another embodiment, rope core 1104 is formed of a polymeric material. In still another embodiment, rope core 1104 comprises a plurality of individual elements (e.g., steel or stainless-steel strands) coiled together. In that case, a woven lay length of about 18 mm is illustratively suitable. However, it is expressly contemplated that rope core 1104 may include a different diameter and lay length based on the desired thickness and length of net rope 1100.

FIG. 12 is a cross-sectional view of a border rope 1200, which is illustratively consistent with embodiments of border ropes described above in relation to other Figures. As shown, border rope 1200 includes six edge rope elements 1202 (an illustrative one has been labeled) woven over a border rope core 1204.

Each edge rope element 1202 is illustratively reinforced internally with a plurality of woven internal wires 1206 that themselves surround a core element. The core element of each rope element 1202 is illustratively a single elongated element (e.g., made of metal or polymeric material) or itself can be a plurality of woven elongated elements (e.g., woven metal wires). In one embodiment, each edge rope element 1202 includes between 7 and 9 internal wires 1206 (e.g., galvanized steel wires) woven around the core for reinforcement. In one embodiment, the weave of internal wires 1206 has a lay length of about 34 mm. Additionally, in one embodiment, each edge rope element 1202 is covered with a weave of fabric elements, such as a woven network of polyester yarns. Each edge rope element 1202 illustratively has a diameter of about 6.6 mm.

Border rope core 1204 is illustratively formed of a metal material, such as steel. In this way, the possibility of tearing and/or otherwise damaging border rope 1200 is minimized. In one embodiment, as shown, border rope core 1204 is comprised of a weave of internal wires 1208 surrounding a central core. For example, border rope core 1204 illustratively includes a weave of six internal wires 1208 around a metal, polymeric, or woven metal core. In one embodiment, each wire 1208 is formed of steel or stainless steel or galvanized steel. Additionally, in one embodiment, the border rope core 1204 is optionally covered with a weave of fabric elements, such as a woven network of polyester yarns.

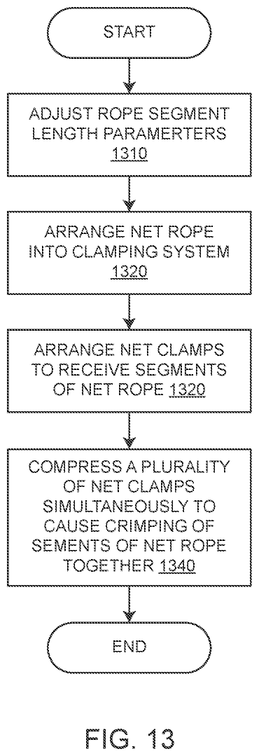

FIG. 13 is a flow diagram showing an example process 1300 for forming a net lattice utilizing one or more net ropes, embodiments of the net lattice and net rope being described above in relation to other Figures. Operation 1300 begins at block 1310 where rope segment length parameters are adjusted. Adjusting rope segment length parameters illustratively comprises adjusting consecutive pairs of clamps within a clamping system. Each pair of clamps will illustratively produce a corresponding length of net rope. Thus, adjusting the pairs of clamps comprises selecting a consecutive series of lengths of net rope. For example, the net lattice shown in FIG. 5 follows a curved playground frame and, as such, different adjacent lengths of net rope will desirably be selected for different measurements of length. Setting the segment length parameters in accordance with block 1310 therefore means setting the pairs of clamps to correspond to desired consecutive lengths of net rope.

Process 1300 then proceeds to 1320 where the net rope (or net ropes) is secured into the clamping system. In one embodiment, this means securing lengths of the net rope into the clamp pairs. As such, each clamp pair produces and holds a desirable length of net rope. In one embodiment, a single stretch of net rope is stretched back and forth across multiple consecutive pairs of clamps, and therefore covering multiple consecutive lengths of net rope. For example, segment 412 of net rope described in relation to FIG. 4 would be secured in one pair of clamps while the next adjacent segment 414 of net rope would go into the next pair of clamps. And so on and so forth.

The process then proceeds to 1330 where a plurality of net clamps, which have been described above in relation to other embodiments, are arranged so as to receive adjacent segments of net rope, each secured in their own pair of clamps. The net clamps are illustratively laid out such that when secured to adjacent segments of net rope the desired pattern of the net lattice will be produced. For example, net clamps are illustratively laid out to eventually secure segments of net rope 412 and 414 together.

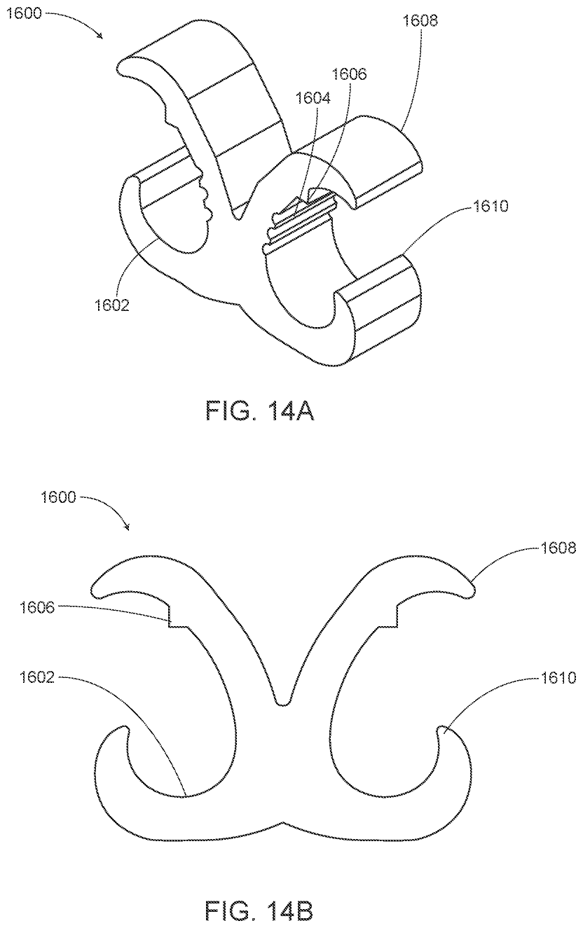

Finally, the process ends with 1340 where compression is simultaneously applied to the plurality of net clamps causing them to securely crimp in consecutive segments of net rope, thereby permanently effectuating the preferred net lattice shape. In one embodiment, all of the net clamps for a single pair of adjacent stretches of net rope are laid out and collectively crimped all at once. In another embodiment, the net clamps for multiple adjacent stretches of net rope are laid out and crimped together simultaneously. Those skilled in the art will appreciate that any combination of multiple net clamps can be simultaneously laid out and crimped. FIGS. 14A-14B (collectively FIG. 14) are perspective views of a net clamp 1600.

Net clamp 1600 is a two-sided hook—one hook on each side to accommodate a segment of net rope on each side (e.g., segments 412 and 414 shown in FIG. 4). As shown, the segments of net rope will not touch one another but the center line axis of each will be brought into a common plane. In embodiment, the net clamp is configured such that the segments will touch. Either way is acceptable depending on the requirements of a given application.

Each net clamp 1600 illustratively includes first and second concave portion 1602 configured to allow insertion of a net rope segment. Concave portion 1602 may be sized such it will eventually secure the net rope segment with little to no room for movement after crimping. Net hook 1600 further includes one or more teeth 1604 to provide slip resistance after crimping. Further a barb 1606 is optionally provided to further discourage net rope segments from slipping once crimped into a concave portion 1602.

The FIG. 14B view of net clamp 1600 actually shows the barb 1606 with teeth 1604 removed, for the purpose of clarity. Either, both, or none of features 1604 and 1606 can be included in the net clamp 1600 design. In general, it is desirable to prevent slippage and/or rotation of the net rope segments and features 1604/1606 will help with that. Additionally, both sides of each net clamp 1600 further include a first lip portion 1608 and second lip portion 1610, which are configured to compress together and secure a net rope segment within the concave portion 1602. This is effectively the crimping of the clamp 1600. In one embodiment, net clamp 1600 has a length of about 15/16 of an inch, with a height of about 11/16 of an inch and a relative thickness of about ¼ of an inch.

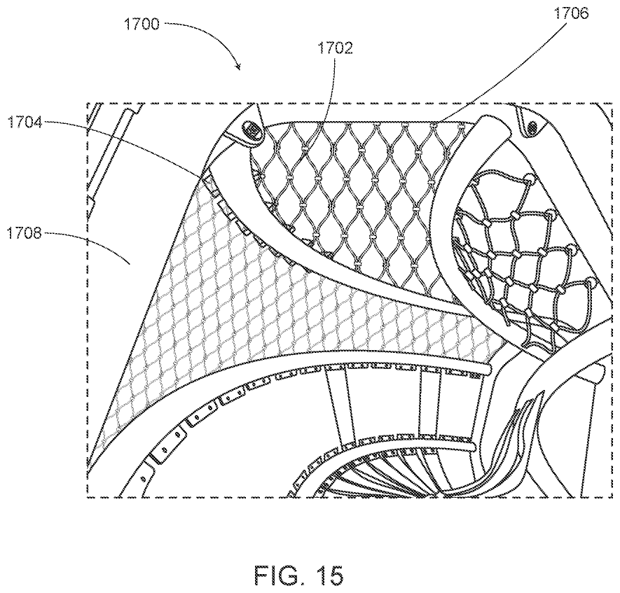

FIG. 15 is a perspective view of a portion of a playground device 1700 illustratively includes a net lattice 1702 coupled to a frame 1708. The purpose of FIG. 15 is to demonstrate the point that there are ways other than a rope hook to couple to a playground device. For example, as shown in FIG. 15, a clamping mechanism 1704 is utilized to secure net lattice 1702 to frame 1708. In another example, one or more eyebolts 1706 are implemented to secure net lattice 1702 to frame 1708. These are just examples of other possible connections suitable for coupling net lattice 1702 to frame 1708.

Embodiments of net ropes described herein, including net rope 1000 in FIG. 10, are illustratively configured so as to include an outer layer (e.g., woven rope fibers 1002 in FIG. 10) and an inner layer (e.g., woven strands 1006 in FIG. 10). In one embodiment, the outer layer is relatively soft because it is substantially comprised of, for example, a fabric material while the inner layer is more rigid because it is substantially comprised of, for example, a metal material. An inner core (e.g., core 1004 in FIG. 10) then runs down the middle of both of the outer and inner layers. These three layers interact together so as to support easy movement of net rope segments relative to each other while still maintaining the long-term shape and structural integrity of the net lattice. The interaction of the layers of the net rope in combination with positioning of the net clamps causes the shape of spaces in the net lattice (e.g., spaces 106 referred in relation to FIG. 1) to be preserved long term even when temporarily deformed, for example, when the net lattice is placed under pressure by a user.

In one embodiment, as has been described, the inner layer (e.g., woven strands 1006 in FIG. 10) of a net rope includes a weave of six metallic elements around a concealed central core. Each of the six metallic elements is actually itself a weave of seven smaller individual strands. Thus, in this case, 42 total strands are utilized in the inner layer (not including the central core inside of the inner layer). In another example, more than 42 strands are utilized in the inner layer. In this way, a thicker and more rigid inner layer is formed to provide further protection of the central core and an increased overall rigidity of the net rope. In one embodiment, the central core that then lies inside of the inner layer is formed of a rigid yet flexible material. For example, the central core may be an elongated polymeric element. It could just as easily be deployed as a metallic element or even a weave of metallic elements in its own right.

The outer layer (e.g., woven rope fibers 1002 in FIG. 10) of the net rope is illustratively effective to moderate environmental conditions, such as temperature changes. It is also relatively soft to the touch. Additionally, the outer layer illustratively provides insulative properties and user isolation from the more temperature sensitive inner layer. The outer layer is illustratively formed from any of a number of materials. Examples of such materials include: a polymeric yarn, elastomeric material, nylon, plastic, or any other material suitable for retaining the aforementioned features of the net rope. In one example, an adhesive is applied outside of the inner layer in order to support its connection to the outer layer and further contribute to the insulative properties of the outer layer of the net rope.

In some examples, the net ropes described herein have a diameter of about 6.6 millimeters. However, in other examples, a different diameter can be utilized as well. For instance, a diameter smaller than 6.6 millimeters can be utilized. In this case, the spacing between rows or columns of net clamps in the net lattice is perhaps best if reduced. A reduction will promote optimization of the performance and durability befits of the net lattice as described herein. Additionally, a diameter larger than 6.6 millimeters can also be utilized. In this case, the spacing between net clamps in the net lattice is perhaps best if increased in order to promote optimization of the same performance and durability benefits.

It should be noted that the net ropes described herein need not be round or circular in all instances. Geometric shapes other than round or circular are possible. For example, the net ropes can be produced with a square, diamond, hexagonal, oval, or any other shape profile preferred in a given net lattice design. In one example, the breaking strength of the net rope, without regard to its shape, is approximately at least 650 kilograms.

As has been alluded to, the shape of spaces in the net lattice (e.g., spaces 106 referred in relation to FIG. 1) need not necessarily be the same or similar to the shapes showed in the Figures. The net clamp configuration can be adjusted to support different net lattice spacings such as square, rectangular, triangular, etc. The vast majority of the shapes within a given net lattice implementation are formed via a combination of four net clamps. However, in some examples, less or more net clamps can be integrated used to form different net lattice spaces. In one example, the perimeter of each net lattice spaces formed within the net lattice is no larger than twenty inches. In this way, the net spaces are large enough to support grappling and/or climbing while preventing climbing through the openings in the net lattice.

As indicated above in relation to the Figures, the spaces in the net lattice (e.g., spaces 106 referred in relation to FIG. 1) are formed using one or more net clamps. The net clamps are illustratively crimped-style connectors that bring together segments of net rope that run parallel to one another. In one embodiment, the net lattice includes at least three net clamps all in-line with one another either horizontally or vertically. Utilizing the net clamps enables the net ropes to not overlap over one another, which is common in traditional rope style playground climbers. Also, the net clamps as described herein enable net ropes and clamp connectors to remain in substantially parallel alignment (i.e., in the same plane) alignment with one another. In one example, the net clamps encompass approximately 100% of the net rope cross sectional thickness and do not form a closed geometric shape. By closing around the net rope, the net clamp compresses the outer jacket of the net rope in order to minimize slipping.

In addition to net lattice formation, the net clamps are configured to secure to the net ropes to prevent and/or minimize damage to the net lattice arrangement. In one example, the minimum load capacity of the net lattice is 20 pounds per square foot. Further, each net clamp can be produced with an interior barb feature configured to grip the net rope in order to further prevent slipping of the net rope. Each net clamp is configured such that it adds friction to the net rope, which prevents and/or minimizes slipping while the net clamp is coupled to the net rope. In one example, the net clamp has a minimum slip resistance of 200 pounds, sufficient to retain and secure the net rope.

In one example, the net ropes described herein as used to form the net lattice include a kink resistant wrap surrounding a polymeric central core. For instance, when folding the net rope to an angle of about 180 degrees, the net rope resists any creasing and/or kinking from the applied force.

Although the present invention has been described with reference to preferred embodiments, workers skilled in the art will recognize that changes may be made in form and detail without departing from the spirit and scope of the invention.

What is claimed is:

1. A playground device that includes a net lattice, the playground device comprising:
first and second segments of a net rope, the net rope being part of the net lattice and comprised of a woven outer layer that surrounds a woven inner layer, and wherein the net lattice is attached either directly or indirectly to the playground device; and
a net clamp that is part of the net lattice, wherein the first and second segments of the net rope run substantially parallel to one another through the net clamp, and wherein the net clamp secures the first segment of net rope to the second segment of net rope at the point at which they run substantially parallel to one another.

2. The playground device of claim 1, wherein the net clamp secures the first segment of net rope to the second segment of net rope at the point at which they run substantially parallel to one another without the first and second segments of net rope coming into contact with one another within the net clamp.

3. The playground device of claim 1, wherein the first and second segments of net rope are each a portion of a single, continuous stretch of net rope.

4. The playground device of claim 1, wherein the woven outer layer is a woven fabric outer layer.

5. The playground device of claim 1, wherein the woven inner layer is a woven metal inner layer.

6. The playground device of claim 1, wherein the woven outer layers is a woven fabric layer and the woven inner layer is a woven metal layer.

7. The playground device of claim 1, wherein the woven inner layer is comprised of a material that absorbs heat more quickly than any material included in the woven outer layer.

8. The playground device of claim 1, further comprising a second net clamp that is also part of the net lattice, the first and second segments of the net rope also running substantially parallel to one another through the second net clamp, and wherein the second net clamp also secures the first segment of net rope to the second segment of net rope.

9. A playground device that includes a net lattice, the net lattice comprising:
a single, continuous, elongated net rope that includes an interior layer of material covered with a soft, woven, outer later, the interior layer being more rigid than the soft, woven, outer layer; and
a plurality of rope clamps that each attach together a first portion of the single, continuous, elongated net rope to a second portion of the single, continuous, elongated net rope.

10. The playground device of claim 9, wherein the plurality of rope clamps is a plurality of crimp clamps that each crimp over the first and second portions of the single, continuous, elongated net rope.

11. The playground device of claim 9, wherein the interior layer of material is a set of elongated metal elements woven together with one another.

12. The playground device of claim 9, wherein the plurality of rope clamps is a plurality of two-sided clamps each configured to receive the first portion on one of its sides and the second portion on the other of its sides.

13. The playground device of claim 9, wherein the plurality of rope clamps is a series of at least three rope clamps all in alignment with one another.

14. The playground device of claim 9, wherein the plurality of rope clamps is a series of at least three rope clamps included in the net lattice that are all in horizontal or vertical alignment with one another.

15. The playground device of claim 9, wherein the interior layer of material is a set of at least 42 separate woven, metallic strands.

16. A playground device that incorporates a net lattice, wherein the net lattice comprises a plurality of net clamps that repeatedly bring a first elongated segment of net rope into and out of parallel alignment with a second elongated segment of net rope, and wherein the first and second elongated segments of net rope are comprised of multiple woven layers of material.

17. The playground device of claim 16, wherein the first and second elongated segments of net rope each comprise an elongated segment of woven conductive material covered with a woven insulator material.

18. The playground device of claim 16 wherein the first and second elongated segments are part of the same net rope.

19. The playground device of claim 16 wherein the first and second elongated segments are part of separate net ropes.

20. The playground device of claim 16, wherein the plurality of net clamps at least three times in a row brings the first elongated segment of net rope into and out of parallel alignment with the second elongated segment of net rope so as to create a repeated series of openings between the first elongated segment of net rope and the second elongated segments of net rope.
